(19) United States
(12) Patent Application Publication
(10) Pub. No.: US 2014/0380380 A1
(43) Pub. Date: Dec. 25, 2014

(54) SYSTEM AND METHOD FOR ENCODING MEDIA WITH MOTION TOUCH OBJECTS AND DISPLAY THEREOF

(71) Applicant: Cinematique, L.L.C., Beverly Hills, CA (US)

(72) Inventors: Kyle Heller, Beverly Hills, CA (US); Randy Ross, New York, NY (US)

(73) Assignee: Cinematique, L.L.C., Beverly Hills, CA (US)

(21) Appl. No.: 13/924,682

(22) Filed: Jun. 24, 2013

(51) Int. Cl. H04N 21/4722; H04N 21/478; H04N 21/81; H04N 21/472

(52) U.S. Cl. CPC H04N 21/4722; H04N 21/47217; H04N 21/47815; H04N 21/812; H04N 21/8133
USPC 725/58

(57) ABSTRACT

A method and system for providing video embedded with a plurality of motion touch enabled objects, each of the motion touch enabled objects corresponding to a given item featured in the video at one or more specific frames of the video. The method comprises providing playback of a motion touch enabled video to a viewer and presenting a plurality of touch objects encoded within the video to the viewer, where each of the plurality of touch objects configured to accept a touch from the viewer. The method further comprises receiving a touch for a given one of the plurality of touch objects from the viewer, presenting a touch feedback to the viewer upon receiving the touch for the given one of the plurality of touch objects, and recording the given touch object.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention described herein generally relates to encoding media with motion touch objects, as well as acting on the section of motion touch objects encoded within the same.

### BACKGROUND OF THE INVENTION

On many occasions an online user may be shown several video advertisements from retailers in a typical Internet browsing session. For example, in order to view an article or video, video advertisements may usually precede the desired content. Video advertisements may present a plurality of products for sale throughout the video. However, with existing online video technology, users are not able to “capture” products appearing in the advertisement video that may be of interest to them. In order to pursue one or more products advertised in the video, a viewer must recall what they saw in the video advertisement and manually visit the website, but a user may put off such a task as it would draw them away from their desired content. Upon finish viewing their desired content, users may forget what they saw in the video advertisement. In some instances, the user may also find it undesirable to visit the advertiser's website to locate specific items he or she may have seen in the advertisement video. As result, valuable sale opportunities are lost due to limitations in online video technology.

Using current video advertising techniques, viewers are not able to capture and save items of interest from within the video. Furthermore, existing advertisement methods do not adequately account for interaction with individual elements in advertisement videos and providing for a convenient video experience conducive to supporting ad impressions, click-through, and sales. There is thus a need to encode media with motion touch objects and display thereof according to embodiments of the present invention, as well as systems and methods for capturing and acting upon the selection of such motion touch objects.

### SUMMARY OF THE INVENTION

The present invention provides a method for providing video embedded with a plurality of motion touch enabled objects, each of the motion touch enabled objects corresponding to a given item featured in the video at one or more specific frames of the video. The method comprises providing playback of a motion touch enabled video to a viewer and presenting a plurality of touch objects encoded within the video to the viewer, where each of the plurality of touch objects configured to accept a touch from the viewer. The method further comprises receiving a touch for a given one of the plurality of touch objects from the viewer, presenting a touch feedback to the viewer upon receiving the touch for the given one of the plurality of touch objects, and recording the given touch object.

A touch feedback may include one of a visual indicator, haptic feedback, vibration, and an audio indicator. According to one embodiment, presenting a plurality of touch objects further comprises presenting a motion touch enabled tracking marker for each of the plurality of touch objects. A motion touch enabled tracking marker may be a visual indicator of a given touch object that is selectable by the viewer.

In another embodiment, the method further comprises receiving a request from the viewer to view the recorded touch object, generating a data card object for the recorded touch object, and presenting the data card object. Generating a data card object for the recorded touch object may comprise determining an object identifier associated with the data card object, retrieving data associated with the object identifier, and populating the data card objected with the retrieved data. The retrieved data may include one or more of a caption, image, title, name, time, and frame information. According to another embodiment, the retrieved data may include instruction for execution upon selection of the data card object.

According to one embodiment, the method further comprises receiving a selection of the data card object from the viewer, retrieving content associated with an object identifier for the selected data card object, loading the retrieved content associated with the object ID into a template, and presenting the loaded template for the selected data card. The retrieved content may include one of additional product information, webpage content, and commerce information. In accordance to another embodiment, the method further comprises receiving a request from the viewer to view a collection of recorded touch objects for a plurality of motion touch enabled videos, generating a data card object for each of the recorded touch objects, and presenting the data card objects.

The present invention provides a system for providing video embedded with a plurality of motion touch enabled objects, each of the motion touch enabled objects corresponding to a given item featured in the video at one or more specific frames of the video. The system comprises a processor and a memory having executable instructions stored thereon that when executed by the processor cause the processor to provide playback of a motion touch enabled video to a viewer and present a plurality of touch objects encoded within the video to the viewer, each of the plurality of touch objects configured to accept a touch from the viewer. The processor receives a touch for a given one of the plurality of touch objects from the viewer and a touch feedback is presented to the viewer upon receiving the touch for the given one of the plurality of touch objects. The processor records the given touch object.

A touch feedback may include one of a visual indicator, haptic feedback, vibration, and an audio indicator. According to one embodiment, the processor is configured to receive a request from the viewer to view the recorded touch object, generate a data card object for the recorded touch object, and present the data card object. Generating a data card object for the recorded touch object may comprise the processor configured to determine an object identifier associated with the data card object, retrieve data associated with the object identifier, and populate the data card objected with the retrieved data. The retrieved data may include one or more of a caption, image, title, name, time, and frame information. In another embodiment, the retrieved data may include instruction for execution upon selection of the data card object.

According to one embodiment, the processor is configured to receive a selection of the data card object from the viewer, retrieve content associated with an object identifier for the selected data card object, load the retrieved content associated with the object ID into a template, and present the loaded template for the selected data card. The retrieved content may include one of additional product information, webpage content, and commerce information.

The present invention provides another method for providing video embedded with a plurality of motion touch enabled objects, each of the motion touch enabled objects corresponding to a given item featured in the video at one or more specific frames of the video. The method comprises providing playback of a motion touch enabled video to a viewer and presenting a plurality of touch objects encoded within the video to the viewer, each of the plurality of touch objects configured to accept a touch from the viewer. The method further comprises receiving a touch for one or more of the plurality of touch objects from the viewer and presenting a touch feedback to the viewer upon receiving a touch for the one or more of the plurality of touch objects. The one or more of the plurality of touch objects is recorded and one or more recorded touch objects are presented to the viewer.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a computing system according to an embodiment of the present invention;

FIG. 2 illustrates an MTE server according to an embodiment of the present invention;

FIG. 3 illustrates a flowchart of a method for displaying a motion touch-enabled video according to an embodiment of the present invention;

FIG. 4 illustrates a flowchart of a method for displaying data card objects according to an embodiment of the present invention;

FIG. 5 illustrates a flowchart of a method for creating data card objects according to an embodiment of the present invention;

FIG. 6 illustrates a flowchart of a method for displaying content from a selected data card object according to an embodiment of the present invention;

FIG. 7 illustrates a flowchart of a method for providing a boutique of data card objects according to an embodiment of the present invention;

FIG. 8 illustrates a flowchart of a method for sharing data card objects according to an embodiment of the present invention;

FIG. 9 illustrates a flowchart of a method for presenting content associated with a touch object in a playing video according to an embodiment of the present invention;

FIG. 10 through FIG. 12 illustrate exemplary motion touch-enabled video player interfaces according to an embodiment of the present invention; and

FIGS. 13 through 15 illustrate exemplary boutique interfaces according to embodiments of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

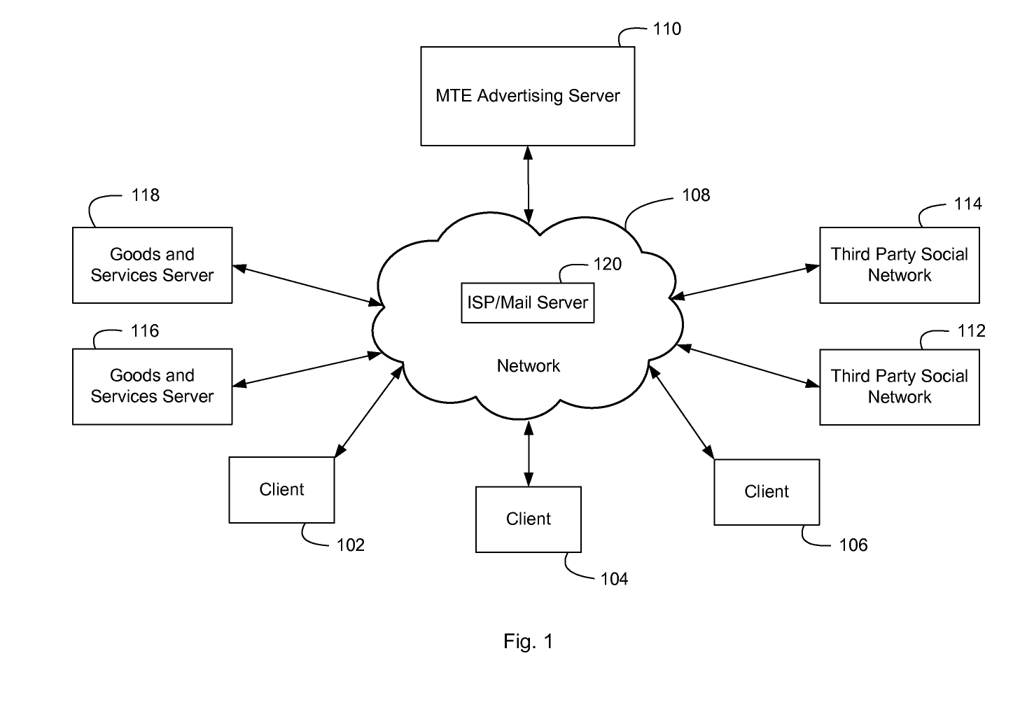

FIG. 1 illustrates a computing system according to an embodiment of the present invention. The system 100 presented in FIG. 1 includes client 102, client 104, client 106, network 108, MTE (motion touch-enabled) advertising server 110, third party social network 112, third party social network 114, goods and services server 116, and goods and services server 118. Clients 102, 104, and 106 may comprise general purpose computing devices (e.g., personal computers, television set top boxes, mobile devices, terminals, laptops, personal digital assistants (PDA), cell phones, tablet computers, e-book readers, or any computing device having a central processing unit and memory unit capable of connecting to a network). Client 102 may also comprise a graphical user interface (GUI) or a browser application provided on a display (e.g., monitor screen, LCD or LED display, projector, etc.). A client device may vary in terms of capabilities or features.

Claimed subject matter is intended to cover a wide range of potential variations. For example, a web-enabled client device, which may include one or more physical or virtual keyboards, mass storage, one or more accelerometers, one or more gyroscopes, global positioning system (GPS) or other location identifying type capability, or a display with a high degree of functionality, such as a touch-sensitive color 2D or 3D display. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games. The foregoing is provided to illustrate that claimed subject matter is intended to include a wide range of possible features or capabilities.

A client device may also include or execute a variety of operating systems, including a personal computer operating system, such as a Windows, Mac OS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook, LinkedIn, Twitter, Flickr, or Google+, to provide only a few possible examples. The term “social network” refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like. A social network may include individuals with similar experiences, opinions, education levels or backgrounds.

An individual's social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to individual communication may have taken place, such as a friend of a friend, or the like. Different privileges or permissions may be associated with relationships in a social network. A social network also may generate relationships or connections with entities other than a person, such as companies, brands, or so called ‘virtual persons.’ An individual's social network may be represented in a variety of forms, such as visually, electronically or functionally. For example, a “social graph” or “socio-gram” may represent an entity in a social network as a node and a relationship as an edge or a link.

MTE advertising server 110 may provide for a platform capable of transforming any video, flash media, and any other multimedia or visual content into “motion touch-enabled” (MTE) content to provide immersive and interactive experiences where viewers, for example, can simply “touch” various items in a video in which he or she is interested. A touch may be interpreted to mean, but not limited to, a mouse click, a tap, a gesture, or any indication of a selection or interaction with a particular item that a video stream displays. A MTE video may be embedded by MTE advertising server 110 with “motion touch objects” or simply, “touch objects,” which provide items within the MTE video that may be touched by a viewer of the MTE video. Viewers may learn about, share information regarding or purchase items associated with objects they have touched from an MTE video.

Objects touched by viewers may be recorded into individualized “boutiques” where viewers may retrieve and view content associated with the objects they have touched for one or more MTE videos. Viewers may create accounts with MTE advertising server 110 to create their boutiques. Alternatively or in conjunction with creating an account, the viewer may also associate social networking accounts with his or her boutique. MTE advertising server 110 may communicate with third party social network 112 and 114 to retrieve a viewer's information from their social networking accounts.

The individual retailers may transmit content from goods and services servers 116 and 118 to MTE advertising server 110 over network 108 for encoding into touch objects within a given video stream. Alternatively, content (and other data) may be encoded into a given video stream from other sources, such as third party sources. Content may comprise video and associated data including descriptions, webpage content, commerce data and time codes within the video associated with several items a goods and services provider may want as touch objects in the video. MTE advertising server 110 may provide MTE video to, for example, retailer websites (via goods and services servers 116 and 118) where clients 102, 104, and 106 may access, by means of network 108, to view the MTE videos. In another embodiment, MTE advertising server 110 may transmit the MTE videos to clients 102, 104, and 106 via HTTP, File Transfer Protocol (FTP), peer-to-peer, email, social media, etc.

MTE advertising server 110, third party social network 112, third party social network 114, goods and services server 116, and goods and services server 118, may be comprised of servers that vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like. Network 108 may be any suitable type of network allowing transport of data communications across thereof. The network 108 may couple devices for the exchange of communications, such as between a server and a client device or other types of devices, for example, including between wireless devices coupled via a wireless network. A network may also include mass storage, such as network attached storage (“NAS”), a storage area network (“SAN”), or other forms of computer or machine readable media, for example.

In one embodiment, the network 108 may be the Internet, following known Internet protocols for data communication (e.g., IP, TCP, TCP/IP, etc.), or any other communication network, e.g., any local area network (“LAN”), or wide area network (“WAN”) connection, wire-line type connections, wireless type connections, or any combination thereof. Network 108 may also include ISP/Mail server 120. ISP/Mail server 120 may represent an Internet service provider or email client services that are operative to transport video, links, or content associated with touch objects of MTE videos, or MTE video itself, from MTE advertising server 110. Sharable MTE videos, links, touch objects and/or associated content may also be shared to social networking sites such as third party social network 112 and 114.

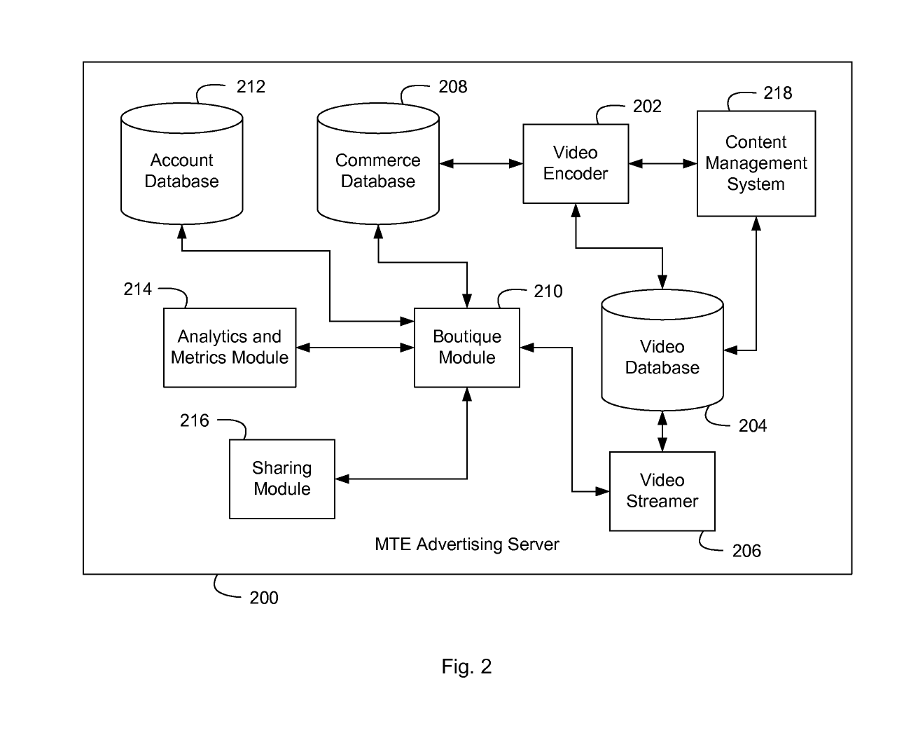

FIG. 2 presents an MTE server according to an embodiment of the present invention. MTE advertising server 200 comprises video encoder 202, video database 204, video streamer 206, commerce database 208, boutique module 210, account database 212, analytics and metrics module 214, sharing module 216, and content management system 218. Content management system 218 is operable to allow users to upload completed media content, such as videos, for conversion to MTE videos. A MTE video may include one or more touch objects embedded therein, which may appear at certain frames of the video. Touch objects may be touched (or otherwise selected) by viewers such that content associated with the touch objects may be recorded to a viewer's boutique. The presence of touch objects may be indicated by means of an indicator that the MTE video displays (MTE tracking markers). A MTE tracking marker may be an icon, caption, bubble, arrow, or any other shape or signage providing a visual indication of an object within a video that is selectable for adding to a boutique of touch objects for a given viewer.

Users of content management system 218 may upload videos via email, FTP, cloud services, social media, or any other method of data transmission to MTE advertising server 200. Through content management system 218, a user may define touchable items in a video provided by the user and specify content associated with the touchable items. For example, an online retailer may upload an advertisement video including a plurality of products. Video database 204 may store the videos uploaded by the users. According to one embodiment, the content management system 218 may re-encode or transcode uploaded video into a particular desired file format.

Users may specify touch items associated with a desired content associated with the touch items using content management system 218. Content management system 218 is operable to allow users to specify the display of touch objects within certain frames of video or upon the appearance of one or more specific items in a video. Users may provide time codes or frames for which a touch object should appear in a specific segment of video as well as a location of a touch object appearing in the video. A user may also provide additional product detail information, webpage content, e-commerce information, links, etc., that can be associated with touch objects within the advertisement video. Users wishing to update their content may do so using content management system 218. Commerce database 208 may store any of the described information, which may be provided with the uploaded videos by the users or selected from disparate sources. Information in commerce database 208 may be indexed, for example, by object numbers or entries that may be referred to by an encoded video.

Video encoder 202 generates MTE video from the videos uploaded by users and touch objects based on user specifications received at content management system 218. An MTE video may be generated by encoding touch objects with the uploaded videos stored in video database 204. Touch objects may be embedded in the video as content data, object ID's, links, or references to data/information specified by users. The MTE videos generated from the uploaded videos may be stored in video database 204. Although illustrated as a single database, video database 204 may comprise a plurality of database devices, structures, and schema storing and maintaining videos uploaded by users and encoded MTE videos.

MTE videos may be shared with various users and viewers by sharing module 216. MTE videos may be shared, embedded and streamed anywhere, allowing e-commerce connections through the content when posted on blogs, media outlets, and social networks. Video streamer 206 is operable to stream the MTE videos for viewing. MTE video may be streamed to any interface and device capable of displaying MTE videos. According to one embodiment, a MTE video may be played or presented in a MTE video player. MTE video capability or an MTE video player client may be seamlessly integrated into webpages, blogs, social media, and other media outlets, e.g., as a plug-in or module. Alternatively, the MTE video player may be software installed on a client device operable to play or stream a MTE video. MTE video player/capability provides touch objects embedded in a MTE video on the video screen, enabling the selection of discrete objects within the video stream. Video streamer 206 may establish a communication connection with a given MTE video player to start a MTE video stream.

In addition, the video streamer 206 is capable of supporting a boutique provided by boutique module 210, which the client may present through an MTE video player. The boutique may be provided along with any MTE video playback session so that viewers can access more in-depth content, as well as purchase the items touched. According to an embodiment of the present invention, a boutique is capable of recording every touch object a viewer touches. The MTE video player may receive touches on touch objects on a client device and communicate the touches to boutique 210 by way of the video streamer 206. Video streamer 206 may identify the touch objects and send the touch objects (or the identification of touch objects, e.g., an object ID) to boutique module 210.

The boutique may store and manage a personal collection of touch objects touched by the viewer. Each viewer may create an account, stored to account database 212, to establish his or her boutique(s) and enable recording of the selection of touch objects in MTE videos to their boutiques. A viewer may explore his or her boutique to view and display content attached to every recorded touch object. A data card object (described in further detail herein) may be generated for each touch object in a viewer's boutique. Boutique module 210 may retrieve data from commerce database 208 to generate and provide data card objects.

In one embodiment, a user may create entries in commerce database 208 including one or more records and fields of information used to generate data card objects. Data card objects may provide “bookmark-like” features for each recorded touch object. For example, a data card object may include a thumbnail image of a frame of video associated with a given touch object retrieved from commerce database 208 to provide a visual indication of what was touched. A data card object may also include information retrieved from commerce database 208 such as the title of the MTE video associated with the touch object, a name of a touched object or item in the MTE video, as well as instructions for execution upon selection of the data card object. Instructions for execution upon selection of a given data card object may include a command to retrieve additional information, webpage content, or commerce information, to navigate to a URL, or a resume play function that plays the MTE video at the time when the touch object associated with the data card object appears in the MTE video. Other instructions and actions should be readily apparent to those of ordinary skill in the art.

In one embodiment, if a viewer permits, boutique module 210 may access information from a user's social networking account and use the information to create a new account in account database 212. The boutique associated with a viewer account may record touches for a plurality of MTE videos. A boutique may be part of any instance of the MTE video player so viewers may access his or her touches anywhere MTE video is embedded. Viewers wishing to share the contents of their boutiques may be provided with a plurality of sharing options through sharing module 216. Boutique content may be shared through, for example, email, social media, blogs, and any other method of dissemination. Boutique contents may include the transmission of content data, links, or object identifiers referencing information at a location, such as in a database, at a URL, or cloud storage location, etc.

MTE videos may enable analytics and metrics module 214 to quantify the items identified therein. When viewers select touch objects within a given MTE video, analytics and metrics module 214 may be operable to assess the effectiveness of the video in its entirety as well as the specific content within the video. The following exemplary factors may be considered by analytics and metrics module 214: 1) the number of views by individual video, groups of videos, or individual item, 2) the number of views that have accessed specific items within a boutique, 3) the number of touches by individual video, groups of videos, or individual item, 4) linkouts of how many users click through to associated e-commerce or website, 5) the amount of touch enabled screen time can be seen by video, groups of videos or individual items, and 6) the number of touched items that reside in universal boutiques around the world at any given time. Such data may form the basis for the calculation of advanced metrics or analytics that may be of interest to advertisers.

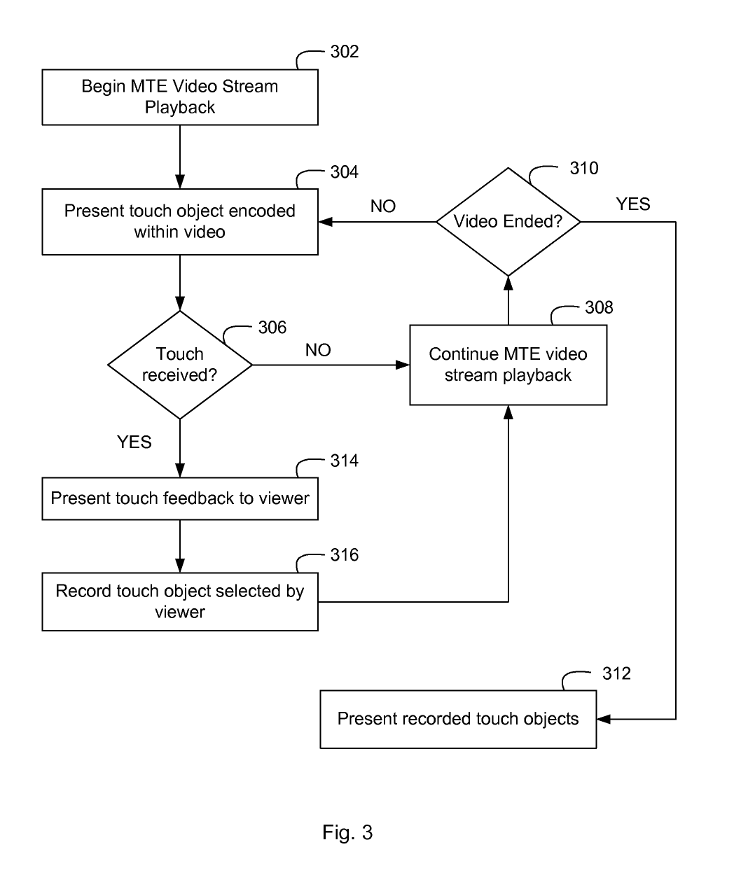

FIG. 3 presents a flowchart of a method for displaying a motion touch-enabled video according to an embodiment of the present invention. A viewer may be provided with a video stream for playback of a given MTE video. MTE video stream playback begins, step 302. The MTE video stream may be streamed from a MTE advertising server and displayed on a MTE player. Throughout playback of the MTE video stream, one or more touch objects encoded within the MTE video may be presented to the viewer, step 304. Presenting the one or more touch objects may include presenting MTE tracking markers to indicate the presence of the one or more touch objects. The one or more touch objects may be associated with items that may be purchased or viewed in greater detail. Touch objects may appear in specific video frames for a duration of time, for example, for the duration of which a corresponding item is displayed in the MTE video.

A check determines whether a touch has been received from the viewer, step 306. A touch may be any interaction with a given touch object presented in the MTE video that manifests a selection of a given touch object. If a touch has not been received, the MTE video stream playback continues, step 308. If a touch has been received, however, touch feedback is presented to the viewer of the MTE video, step 314. A touch feedback may include, but not limited to, one or more of the following: a visual indicator, haptic feedback, vibration, an audio indicator, such as a ringtone, or other feedback as is known to those of skill in the art.

In a next step 316, the touch object selected by the viewer is recorded. The touch object may be recorded to, for example, the viewer's boutique, which may be made globally (in a collection of MTE videos) or in conjunction with the given MTE video. After recording the touch object selected by the viewer, the method proceeds to step 308. In step 308, the MTE video stream playback continues. If the video has not ended at step 310, the method proceeds back to step 304 and continues to present touch objects encoded within the MTE video. A determination in step 310 that the video has ended results in the method proceeding to step 312 where the recorded touch objects are presented to the viewer of the MTE video.

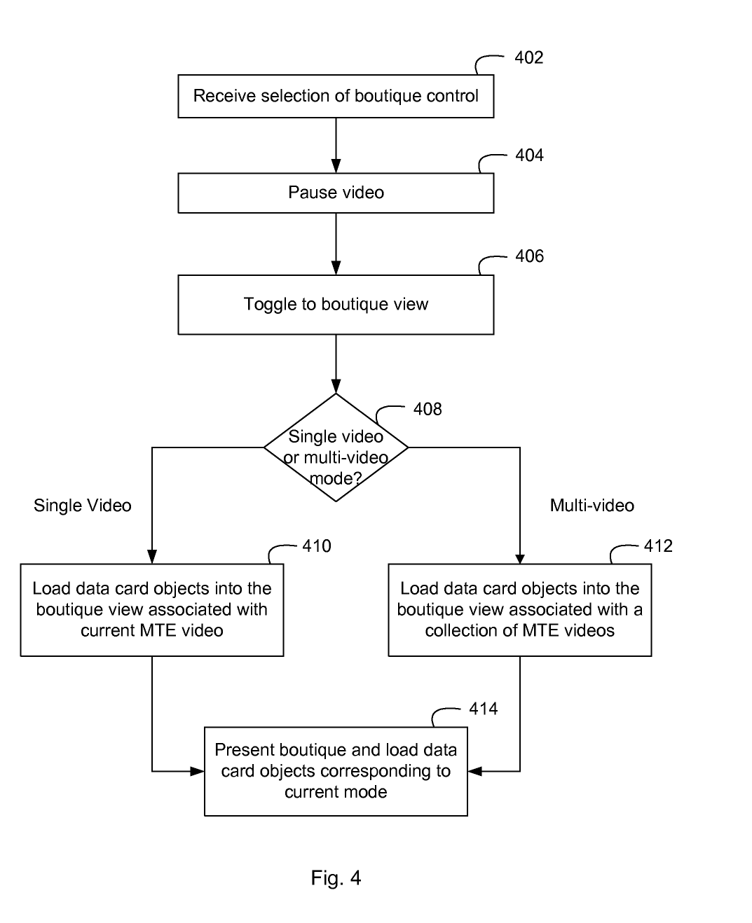

FIG. 4 presents a flowchart of a method for displaying data card objects according to an embodiment of the present invention. Touch objects touched by a viewer for a given MTE video may be recorded and stored as data card objects to the viewer's boutique. A selection of a boutique control is received, step 402. The boutique control may be, for example, an icon selected by the viewer on the MTE video player. Upon selection of the boutique control, the MTE video may be paused, step 404 and the MTE video player toggles from a video playback view to a boutique view, step 406. The boutique view may provide for the display of one or more data card objects corresponding to the touch objects touched by the viewer, if any.

A determination is made whether the viewer desires to view data card objects in a single video mode or a multi-video mode, step 408. The viewer may select either one of single video mode or multi-video mode as the current mode for the boutique, e.g., through selection of a control that the user interface presents to execute such a preference. The single video mode may provide the viewer with the option to display data card objects for a current MTE video the viewer is watching. The multi-video mode may provide the viewer with the option to display data card objects of the viewer's recorded touch objects for a plurality of MTE videos, including data card objects for the current MTE video. If the current mode is the single video mode, data card objects associated with the current MTE video are loaded into the boutique view, step 410. However, if the current mode is the multi-video mode, card objects associated with a collection of MTE videos are loaded into the boutique view, step 412. In a next step 414, the boutique is presented and loaded with data card objects corresponding to current mode.

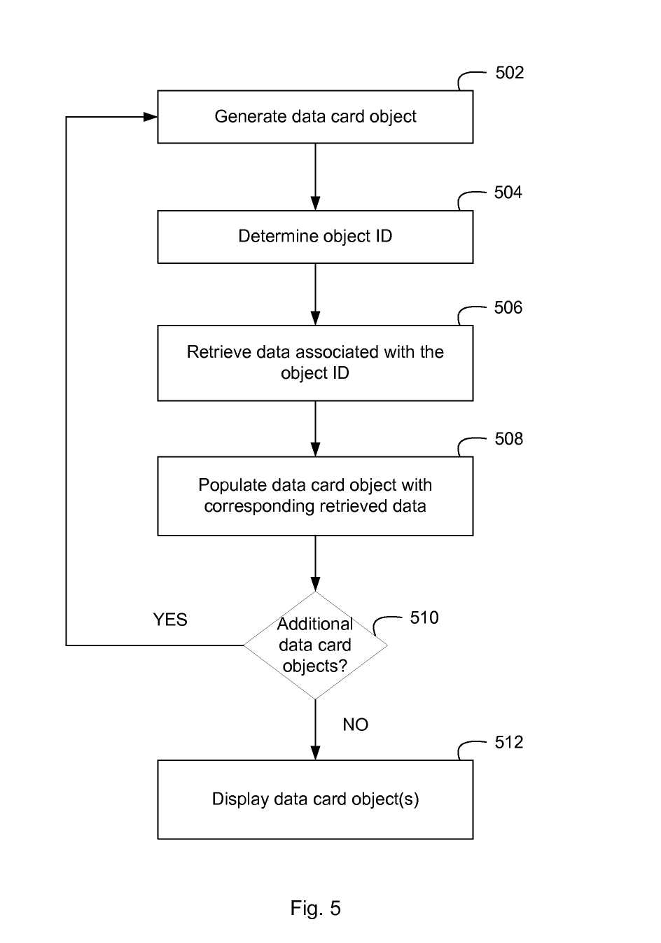

FIG. 5 presents a flowchart of a method for creating data card objects according to an embodiment of the present invention. Data card objects may be presented to a viewer in their boutique. A given data card object may include a visual indication of a frame of a MTE video corresponding to a given touch object touched by the viewer. In a given boutique, a data card object is generated, step 502. In a next step 504, the object ID of the data card object is determined. The object ID may identify content designated for the data card object associated with the given touch object. An object ID may be used to locate an entry of information in, for example, a database including information for a given data card object.

Data associated with the object ID is retrieved, step 506. The data may include a caption, image, title, name, time/frame information, or any other kind of metadata associated with a touch object in a MTE video, and instructions for execution upon selection of the data card object. The data card object is populated with the corresponding retrieved data, step 508. A determination is made whether there are additional data card objects in the boutique, step 510. If additional data card objects exist, the method proceeds to step 502 to generate another data card object. Steps 502 through 510 may continue until there are no data card objects left in the boutique, at which point the data card object(s) are presented for display, step 512.

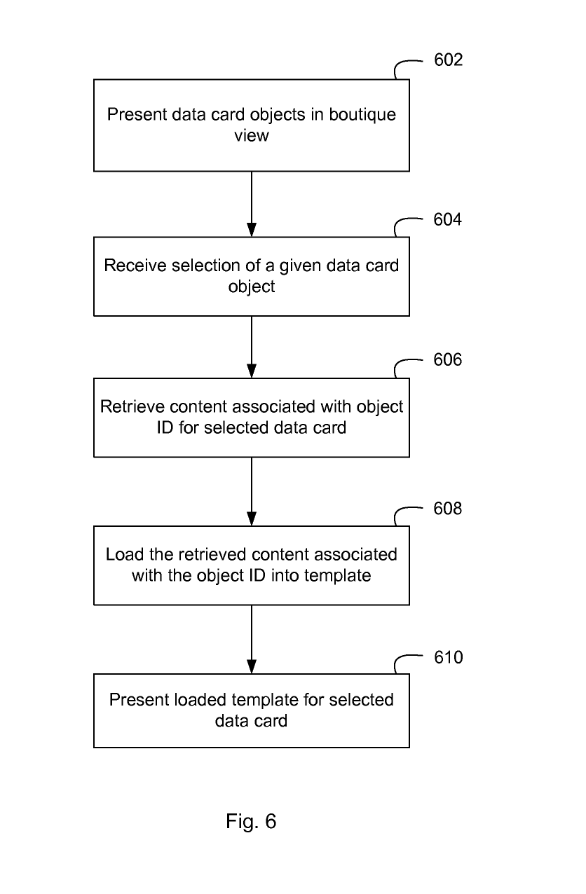

FIG. 6 presents a flowchart of a method for displaying content from a selected data card object according to an embodiment of the present invention. The boutique view may present one or more data card objects, step 602. The one or more data card objects may represent various touch objects associated with one or more MTE videos, according to a current mode (e.g., single video or multi-video mode). A selection of a given data card object is received, step 604. Each data card object may include instructions for execution upon selection of the data card object. A viewer may select a given data card object to view additional details, webpage content, or commerce information corresponding to a touch object in a MTE video.

In a next step 606, the content associated with an object ID for the selected data card is retrieved. The object ID may refer to an entry or record from a data source, such as a database, server, or cloud storage location of which content is retrieved. The retrieved content associated with the object ID is loaded into a template, step 608. A template may be a “container” or empty (graphical user interface) form that may be populated with any type of content or data that may be retrieved with the object ID. The populated template is presented for the selected data card, step 610.

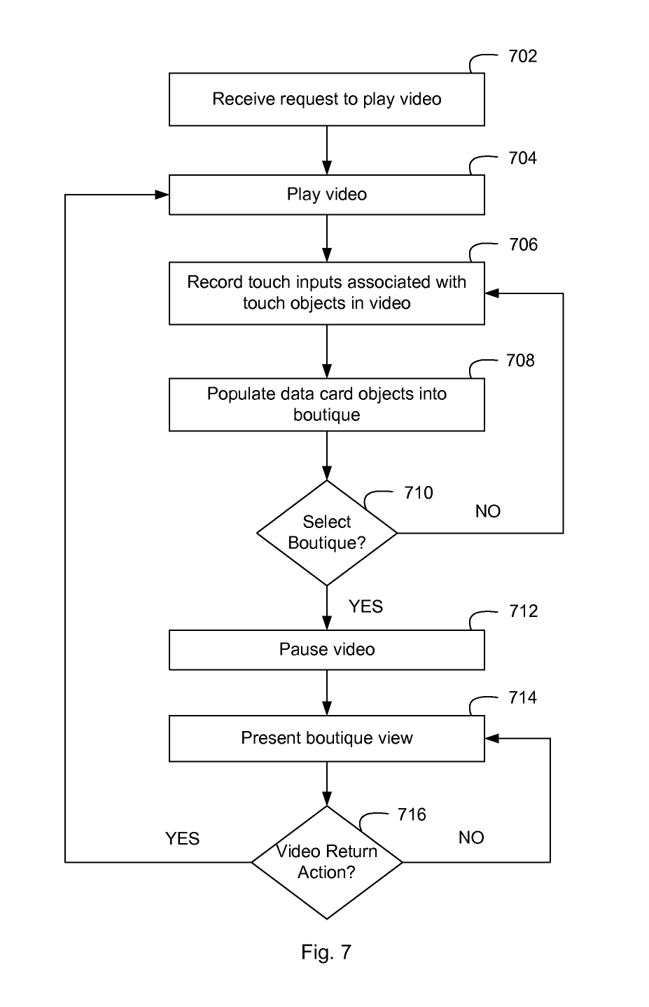

FIG. 7 presents a flowchart of a method for providing a boutique of data card objects according to an embodiment of the present invention. In an exemplary “touch and save” video playback mode, wherein touches may be recorded without pausing video playback, a request to play a MTE video is received, step 702. The MTE video is played, step 704. One or more touch objects may be presented to a viewer in the MTE video during playback. The viewer may touch the one or more touch objects that are of interest to the viewer. Touch inputs associated with touch objects in the MTE video are recorded, step 706. That is, valid touches on touch objects are recorded. The presence of touch objects may be indicated during MTE video playback. A valid touch may include a click, tap, or any indication of selection on a touch object. There may be instances in the MTE video where touch objects are not present. A click, tap or selection on a region within the MTE video in the absence of a touch object may not be recorded or acknowledged as a touch.

Data card objects are populated into a boutique of the viewer, step 708. The data card objects correspond to the touch inputs recorded for the touch objects in the MTE video. A determination is made whether the viewer has selected the boutique, step 710. The method continues with step 706, with the system continuing recording touch inputs associated with touch objects in the playing MTE video where the viewer does not select the boutique. If the viewer selects the boutique, the video is paused, step 712, and the system presents the boutique view to the viewer, step 714. The boutique may continue to display until receipt of a video return action, step 716. A video return action may include any indication from the viewer to resume playing of the MTE video. Receiving a video return action at step 716 will cause the method to continue with step 704 and play the MTE video.

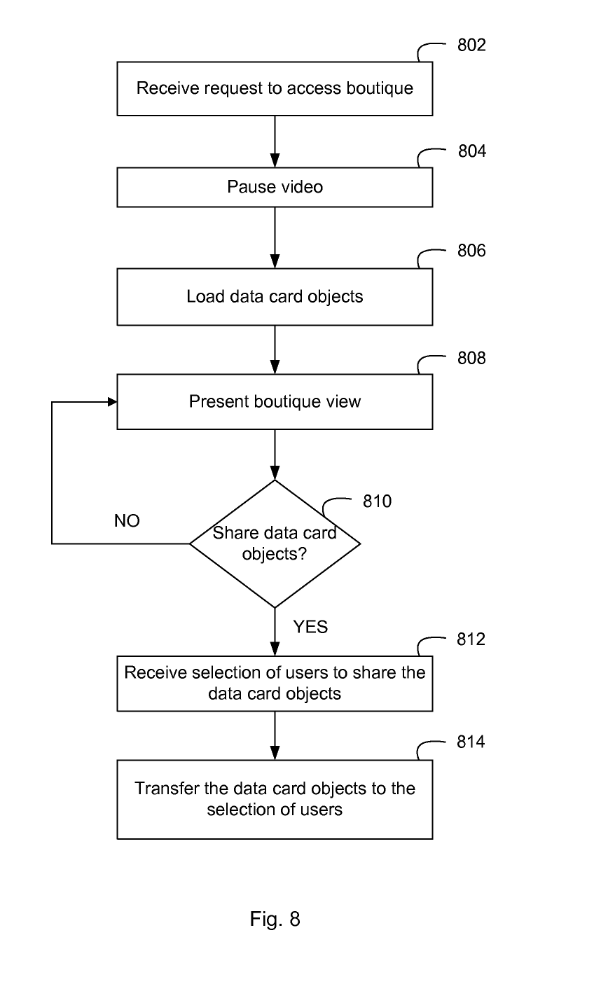

FIG. 8 presents a flowchart of a method for sharing data card objects according to an embodiment of the present invention. A viewer may share data card objects from his or her boutique(s) with one or more other viewers or users. For example, the viewer may touch on one or more touch objects associated with products of interest in a MTE video and wish to share information on these products with friends or family. Sharing may be accomplished when a request to access a boutique is received from the viewer, step 802. The video is paused in step 804. In a next step 806, data card objects are loaded to the viewer's boutique, step 806.

A boutique view is presented to the viewer, step 808. The boutique view may offer the viewer an option to share one or more data card objects in the boutique to others. Data card objects may be shared through email, social media, blogs, etc. The method determines if the viewer has selected to share data card objects in step 810. The boutique view will be continued to be presented to the viewer if the viewer does not select to share data card objects.

If the viewer selects to share data card objects, the system may prompt the viewer for a selection of users with which to share the data card objects. In a next step 812, a selection of users to share the data card objects is received. Receiving the selection of users may also include a selection of data card objects to share. The data card objects are transferred to the selection of users, step 814. Transfer of data card objects to the selection of users may include transferring data used to populate the data card objects, or transferring the object ID's of the data card objects.

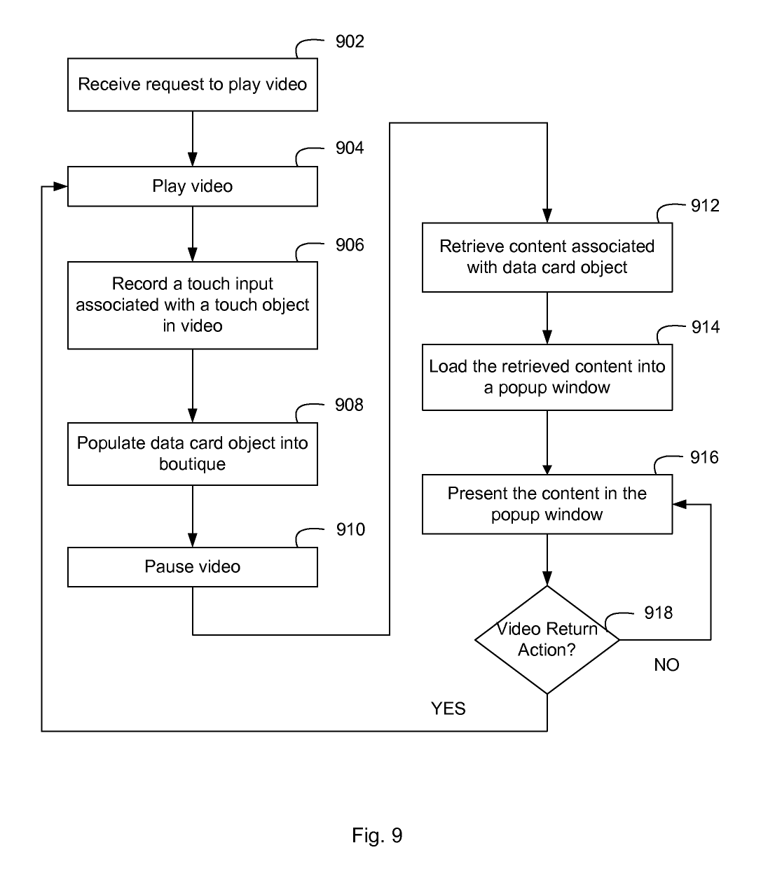

FIG. 9 presents a flowchart of a method for presenting content associated with a touch object in a playing video according to an embodiment of the present invention. In an exemplary “pause and resume” video playback mode, a request to play a MTE video is received, step 902. The MTE video is played, step 904. One or more touch objects may be presented to a viewer in the MTE video during playback. The viewer may touch a given touch object that is of interest to the viewer. A touch input associated with a touch object in video is recorded, step 906. A data card object associated with the touch object is populated into a boutique, step 908. In the present exemplary “pause and resume” video playback mode, the MTE video is paused, step 910, upon recording each touch input associated with a touch object.

Content associated with the data card object is retrieved, step 912. The content associated with the data card object may include instructions for execution upon selection of the data card object. For example, the viewer may be presented with additional details, webpage content, or commerce information corresponding to the touch object in the MTE video. Retrieving content may include identifying an object ID for the selected data card. The object ID may refer to an entry or record from a data source, such as a database, server, or cloud storage location of which content is retrieved. The retrieved content is loaded into a popup window, step 914. In a next step, the content in the popup window is presented, step 916. The content in the popup window will continue to be presented to the viewer until the viewer selects a video return action. Upon determining that the viewer has selected a video return action, step 918, the method returns to step 904 and plays the MTE video.

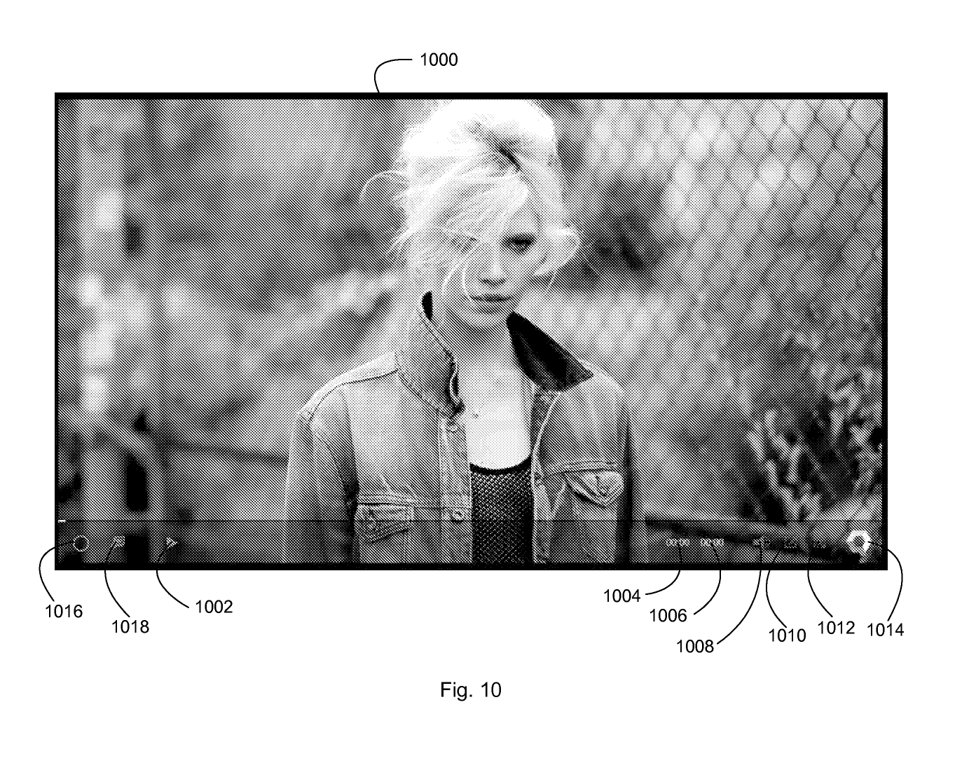

FIG. 10 presents an exemplary MTE video player interface. MTE videos may be played or presented on MTE video player 1000. MTE video player 1000 includes a play/pause control 1002, time elapsed indicator 1004, video duration indicator 1006, volume control 1008, sharing control 1010, full screen control 1012, boutique icon 1014, MTE tracking marker toggle control 1016, and playback mode selector 1018. Play/pause control 1002 is configured to start or continue play a given MTE video on MTE video player 1000 while the given MTE video is either stopped or paused. If the given MTE video is playing, play/pause control 1002 may be selected to pause the MTE video. Time elapsed indicator 1004 displays the amount of time a MTE video has played and video duration indicator 1006 displays the total duration of the MTE video. Volume control 1008 may be selected by the viewer to decrease, increase, or mute the volume of a MTE video on MTE video player 1000.

Sharing control 1010 is operable to provide the viewer with the ability to share a MTE video. The video may be shared by means of email, posting to blogs and social media networks, or any other media outlets. Full screen control 1012 is operable to allow the viewer to toggle between a full-screen view of a MTE video and a window view of the MTE video. Boutique icon 1014 may be selected by a viewer to display a boutique of data cards associated with the viewer's touches on MTE video touch objects. MTE tracking marker toggle control 1016 allows viewers to toggle on or off MTE tracking markers. MTE tracking markers can help assist viewers in identifying touchable items. However, MTE tracking markers may be disabled if they are distracting to the viewer of the MTE video. Playback mode selector 1018 allows a viewer to select between a “touch and save” mode (e.g., with respect to the description of FIG. 7) and a “pause and resume” mode (e.g., with respect to the description of FIG. 9).

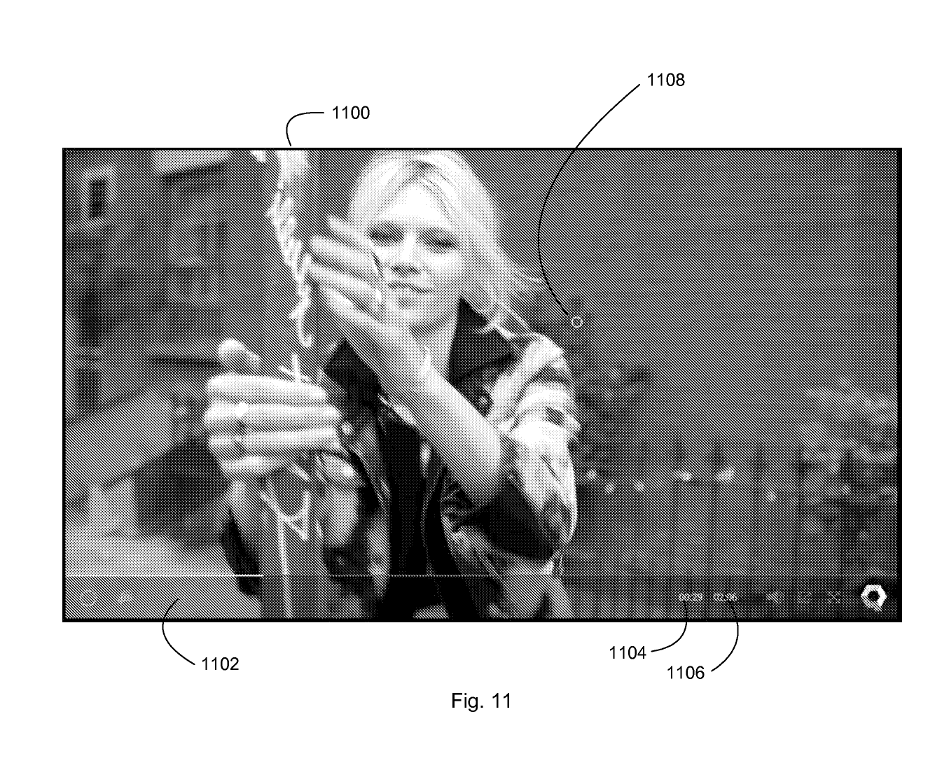

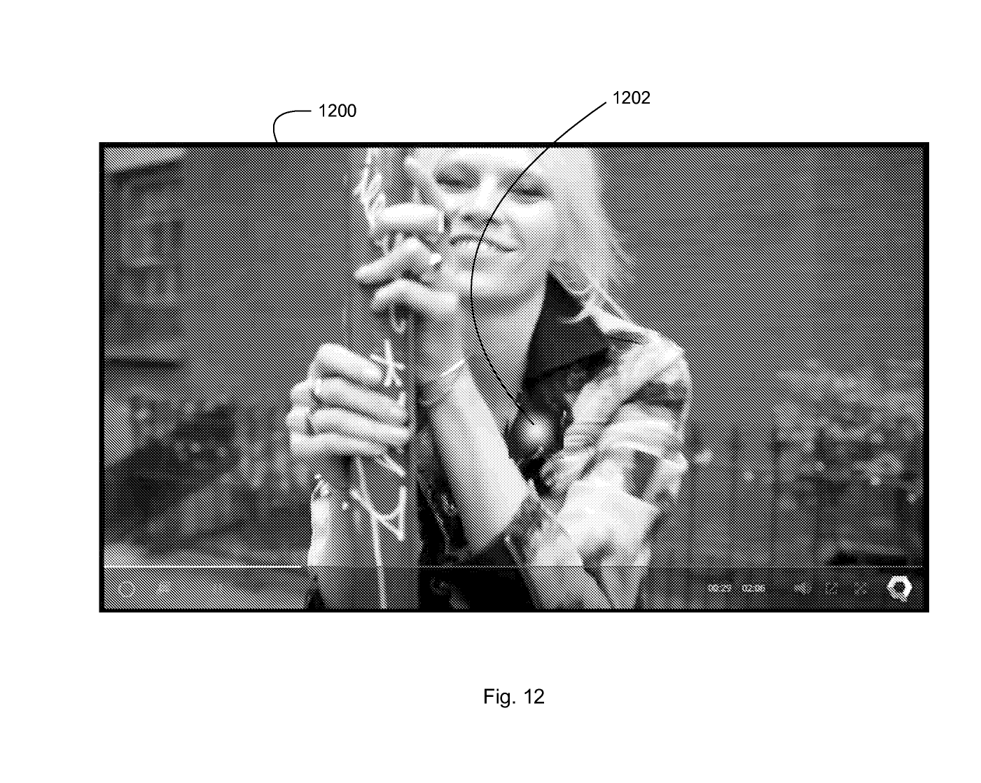

FIG. 11 presents playback of a MTE on an exemplary MTE video player interface. MTE video player 1100 presents a playing MTE video. Play/pause control 1102 allows a viewer to pause the currently playing MTE video. As illustrated, time elapsed indicator 1104 indicates a current play time of 00:29 out of a total video duration of 02:06 as shown by video duration indicator 1106. MTE tracking marker 1108 is an exemplary visual indicator of a touch object within the MTE video a viewer may touch. The viewer may touch the touch object to indicate an interest in an item corresponding to the touch object. Upon selection of the touch object, the viewer may be provided with a touch feedback as illustrated in FIG. 12. FIG. 12 presents the MTE video playing in MTE video player 1200 where the viewer has touched a touch object. The touch is registered and a touch visual feedback 1202 is displayed as a flash, as illustrated.

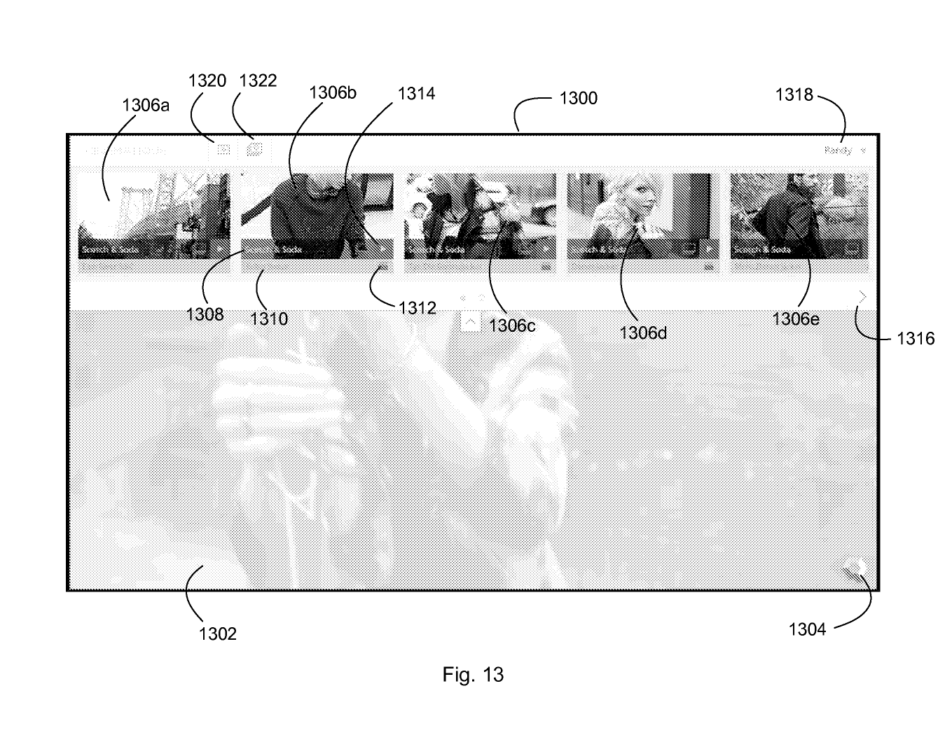

FIG. 13 presents an exemplary boutique view according one embodiment of the present invention. Selecting the boutique icon on the MTE video player, such as the boutique icon 1014 shown in FIG. 10 (corresponding to the boutique icon 1304 shown in FIG. 13), presents the viewer with a boutique including the viewer's data card objects associated with touch objects touch by the viewer during a MTE video. While in the boutique view, boutique icon 1304 may be selected to close the boutique view and return view to MTE video player. Boutique 1300 includes MTE video player 1302, data cards 1306a, 1306b, 1306c, 1306d, 1306e, scroll 1316, viewer name 1318, single video mode control 1320, and multi-video mode control 1322. As illustrated in FIG. 13, MTE video player 1302 may be shown in an obscured manner while in the background of the view boutique view. Each instance of a boutique may be individually owned by a unique viewer. The owner of the boutique 1300 may be displayed (viewer's name 1318) and provide controls to configure the boutique, the viewer's profile, settings, etc.

The illustrated boutique view presents the viewer with a plurality of data cards 1306a through 1306e. Additional data cards, if any, may be viewed by selecting scroll 1316 to navigate through a plurality of data cards. Referring to data cards 1306b, each data card includes a title of video 1308, touch object name 1310, data card content indicator 1312, and playback bookmark 1314. The title of video 1308 displays a title of a MTE video corresponding to data card 1306b. Touch object name 1310 displays the name of a touch object corresponding to data card 1306b. The touch object name 1310 may be a name of a product or a description of an item associated with the touch object. Playback bookmark 1314 provides a feature where the viewer may return to a specific time or part of an MTE video corresponding to the data card generated for a touch object.

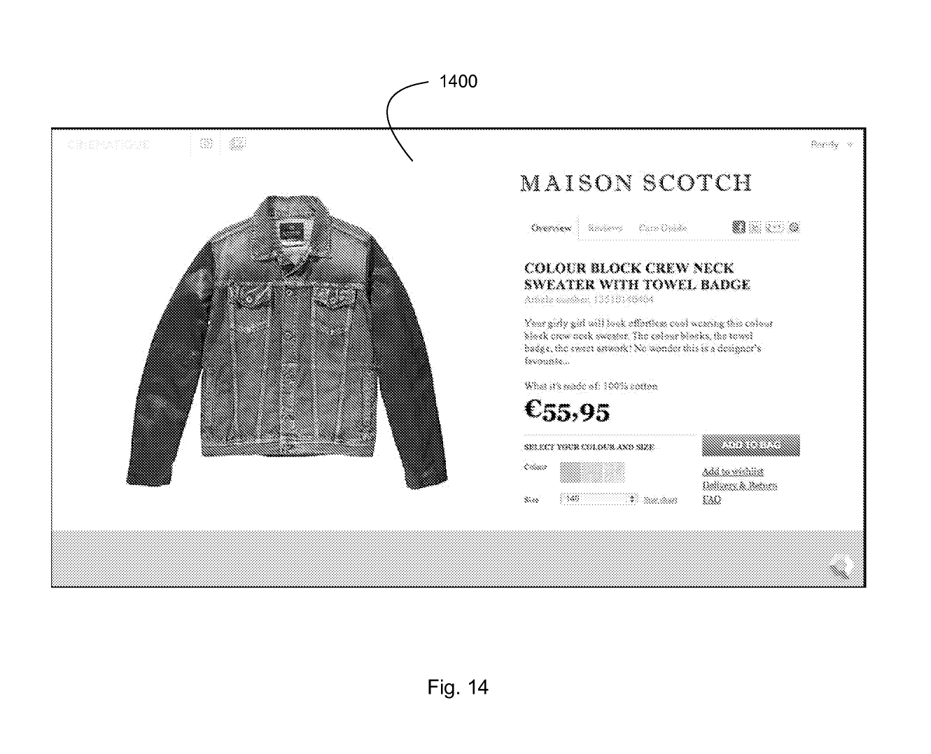

Data card content indicator 1312 may be an icon identifying the type of information contained in a given data card. The information contained in a data card may be presented to the viewer upon selection of the data card. For example, data card content indicator 1312 may indicate to the viewer that selecting the data card will display product and purchasing information. Selecting a data card may display a template populated with the type of data indicated by content indicator 1312. Data card content indicator 1312 can also indicate a data card containing other types of content such as a link to a web page, contact information, image, video, etc. FIG. 14 presents an exemplary template 1400 including product and purchasing information for data card 1306b. A template such as template 1400 may be populated with various content, forms and functions. For example, a template may be populated with web page content, social media network sharing buttons, documents, or images.

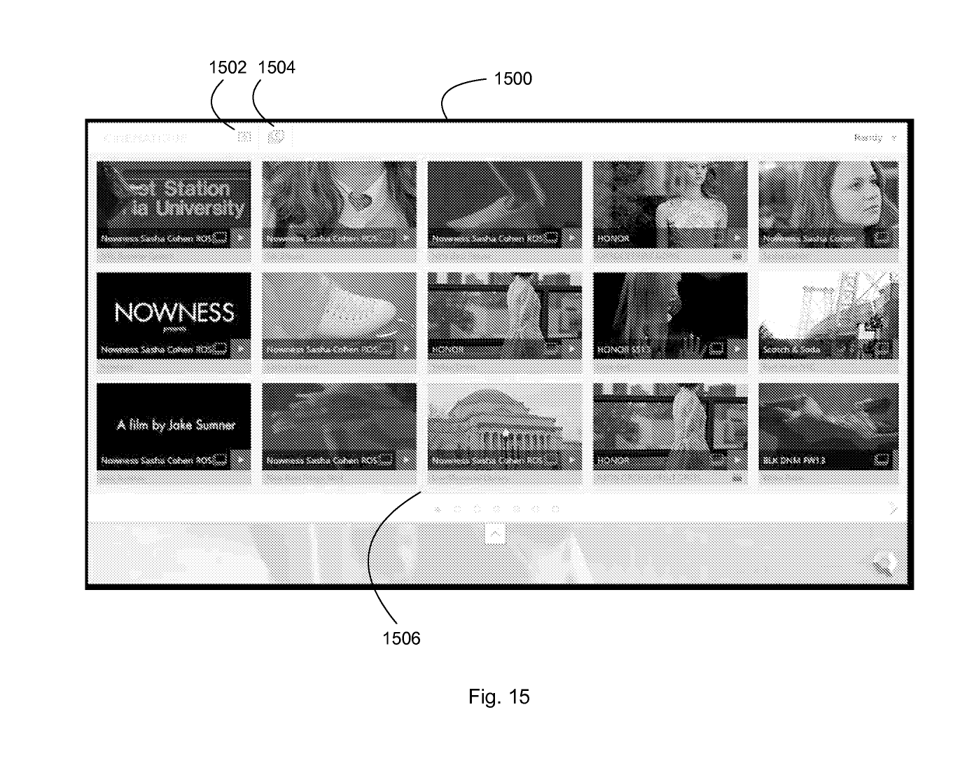

Referring back to FIG. 13, the current mode of the illustrated boutique view is in the single video mode and displays data cards for a current MTE video. According to one embodiment, the single video mode may be a default boutique view mode presented to the viewer. Single video mode may also be selected using single video mode control 1320. Multi-video mode control 1322 may be selected by a viewer to switch to a multi-video mode. In the multi-video mode, the boutique may display a collection of data cards for a plurality of MTE videos. FIG. 15 presents an exemplary boutique view in a multi-video mode according one embodiment of the present invention. Boutique 1500 includes a plurality of data cards 1506 from multiple MTE videos. The viewer may toggle between single video mode and multi-video mode using single video mode control 1502 and multi-video mode control 1504.

FIGS. 1 through 15 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for providing video embedded with a plurality of motion touch enabled objects, each of the motion touch enabled objects corresponding to a given item featured in the video at one or more specific frames of the video, the method comprising:
providing playback of a motion touch enabled video to a viewer;
presenting a plurality of touch objects encoded within the video to the viewer, each of the plurality of touch objects configured to accept a touch from the viewer;
receiving a touch for a given one of the plurality of touch objects from the viewer;
presenting a touch feedback to the viewer upon receiving the touch for the given one of the plurality of touch objects; and
recording the given touch object.

2. The method of claim 1 wherein a touch feedback includes one of a visual indicator, haptic feedback, vibration, and an audio indicator.

3. The method of claim 1 wherein presenting a plurality of touch objects further comprises presenting a motion touch enabled tracking marker for each of the plurality of touch objects.

4. The method of claim 3 wherein a motion touch enabled tracking marker is a visual indicator of a given touch object that is selectable by the viewer.

5. The method of claim 1 further comprising:
receiving a request from the viewer to view the recorded touch object;
generating a data card object for the recorded touch object; and
presenting the data card object.

6. The method of claim 5 wherein generating a data card object for the recorded touch object comprises:
determining an object identifier associated with the data card object;
retrieving data associated with the object identifier; and
populating the data card objected with the retrieved data.

7. The method of claim 6 wherein the retrieved data includes one or more of a caption, image, title, name, time, and frame information.

8. The method of claim 6 wherein the retrieved data includes instruction for execution upon selection of the data card object.

9. The method of claim 5 further comprising:
receiving a selection of the data card object from the viewer;
retrieving content associated with an object identifier for the selected data card object;
loading the retrieved content associated with the object ID into a template; and
presenting the loaded template for the selected data card.

10. The method of claim 9 wherein the retrieved content includes one of additional product information, webpage content, and commerce information.

11. The method of claim 1 further comprising:
receiving a request from the viewer to view a collection of recorded touch objects for a plurality of motion touch enabled videos;
generating a data card object for each of the recorded touch objects; and
presenting the data card objects.

12. A system for providing video embedded with a plurality of motion touch enabled objects, each of the motion touch enabled objects corresponding to a given item featured in the video at one or more specific frames of the video, the system comprising:
a processor; and
a memory having executable instructions stored thereon that when executed by the processor cause the processor to:
provide playback of a motion touch enabled video to a viewer;
present a plurality of touch objects encoded within the video to the viewer, each of the plurality of touch objects configured to accept a touch from the viewer;
receive a touch for a given one of the plurality of touch objects from the viewer;
present a touch feedback to the viewer upon receiving the touch for the given one of the plurality of touch objects; and
record the given touch object.

13. The system of claim 12 wherein a touch feedback includes one of a visual indicator, haptic feedback, vibration, and an audio indicator.

14. The system of claim 12 wherein the processor is configured to:
receive a request from the viewer to view the recorded touch object;
generate a data card object for the recorded touch object; and
present the data card object.

15. The system of claim 14 wherein generating a data card object for the recorded touch object comprises the processor configured to:
determine an object identifier associated with the data card object;
retrieve data associated with the object identifier; and
populate the data card objected with the retrieved data.

16. The system of claim 15 wherein the retrieved data includes one or more of a caption, image, title, name, time, and frame information.

17. The system of claim 15 wherein the retrieved data includes instruction for execution upon selection of the data card object.

18. The system of claim 14 wherein the processor is configured to:
receive a selection of the data card object from the viewer;
retrieve content associated with an object identifier for the selected data card object;
load the retrieved content associated with the object ID into a template; and
present the loaded template for the selected data card.

19. The system of claim 18 wherein the retrieved content includes one of additional product information, webpage content, and commerce information.

20. A method for providing video embedded with a plurality of motion touch enabled objects, each of the motion touch enabled objects corresponding to a given item featured in the video at one or more specific frames of the video, the method comprising:
providing playback of a motion touch enabled video to a viewer;
presenting a plurality of touch objects encoded within the video to the viewer, each of the plurality of touch objects configured to accept a touch from the viewer;
receiving a touch for one or more of the plurality of touch objects from the viewer;
presenting a touch feedback to the viewer upon receiving a touch for the one or more of the plurality of touch objects;
recording the one or more of the plurality of touch objects; and
presenting the one or more recorded touch objects to the viewer.
